(19) United States
(12) Patent Application Publication
(10) Pub. No.: US 2014/0240174 A1
(43) Pub. Date: Aug. 28, 2014

(54) METHOD AND APPARATUS FOR DETERMINING NON-LINE OF SIGHT (NLOS) AROUND A GPS RECEIVER

(71) Applicant: Electronics and Telecommunications Research Institute, Daejeon-si (KR)

(72) Inventors: Yoo-Seung SONG, Daejeon-si (KR); Sang-Joon Park, Daejeon-si (KR); Yun-Ju Baek, Busan-si (KR); Sang-Hyun Son, Busan-si (KR)

(21) Appl. No.: 13/921,485

(22) Filed: Jun. 19, 2013

(30) Foreign Application Priority Data
Aug. 20, 2012 (KR) 10-2012-0090884

(51) Int. Cl. G01S 19/28

(52) U.S. Cl. CPC G01S 19/28
USPC 342/357.67

(57) ABSTRACT

Provided are a method and device for determining a non-line of sight (NLOS) state around a GPS receiver. The method may include collecting, from at least one satellite, satellite information including a direction angle, a signal to noise (SNR), and an altitude, selecting a satellite of which the NLOS state is to be determined based on an altitude value of the collected satellite information, and determining whether the selected satellite is in the NLOS state with respect to a direction to the satellite based on the SNR and direction angle included in the satellite information of the selected satellite. According to the present invention, by reducing a location calculation error that occurs due to a distance measurement error when a location is measured, a more precise result of location measurement can be obtained.

### CROSS-REFERENCE TO RELATED APPLICATION

This application claims the benefit under 35 U.S.C. §119(a) of a Korean Patent Application No. 10-2012-0090884, filed on Aug. 20, 2012, the entire disclosure of which is incorporated herein by reference for all purposes.

### BACKGROUND

1. Field

The following description relates to a method and device for determining a non-line of sight (NLOS) state around a global positioning system (GPS) receiver.

2. Description of the Related Art

A global positioning system (GPS) and a real time locating system (RTLS) are currently widely used positioning systems. The GPS, in which a GPS receiver receives signals transmitted from 24 middle earth orbit satellites to measure a location, is widely used in various fields. The GPS satellites are such arranged that at least six GPS satellites are observed at most places on the ground. Each GPS satellite continuously broadcasts a navigation message including satellite state information, a time and error of a clock installed in the satellite, orbit information and almanac, ephemeris, and coefficients for correcting errors.

A GPS receiver calculates a location through trilateration using information obtained by converting an electric wave transmission time between a satellite and the receiver into a distance. The GPS receiver which receives electric waves from a plurality of satellites needs to screen the satellites so that a dilution of position (DOP) is minimized, thereby minimizing incorrectness of location measurement. The DOP which indicates uniformity of a satellite arrangement has a value that varies with the satellite arrangement when calculating a location. As the value increases or decreases, an induced error increases or decreases. However, the DOP does not consider a situation of non-line of sight (NLOS) between the receiver and the satellite. Therefore, when a satellite which is in the NLOS state at a place where a lot of obstacles exist is used to measure a location, location measurement accuracy may degrade even if the DOP is low.

The RTLS includes an anchor node that is a criterion of location information and a sensor node that is an object of measurement. In the RTLS, a distance is measured based on a wireless communication. The RTLS is cheaper than the GPS, consumes low power, and is applicable in an indoor environment, and thus attracts a great attention. However, in order to accurately measure a location through trilateration, at least three anchor nodes should be installed and a distance to the sensor node should be measured in a line of sight (LOS) state.

That is, in the NLOS state where an obstacle exists between the node and the anchor, a wireless signal does not transmitted straightly but is reflected by a wall or another obstacle so as to be transmitted. This phenomenon causes a great error when a distance between two devices and locations thereof are measured based on the wireless signal. Therefore, the measurement accuracy of the RTLS may be relatively improved by reducing errors considering the NLOS environment, or by excluding a measurement result obtained under the NLOS environment. However, it is very difficult to distinguish the NLOS through a measurement result. Therefore, it is difficult to utilize the RTLS in an environment where a lot of obstacles exist.

Various techniques have been developed to overcome the problems of the NLOS environment and improve the measurement performance of the RTLS.

For example, Korean Patent Application Laid-open Publication No. 10-2009-0030253, which relates to a method of selecting an optimal threshold of an arrival time estimator, discloses a technique of selecting an optimal threshold value having a minimal mean square error (MSE) in the LOS or NLOS state when an arrival time of a reception signal between wireless devices is measured using an SNR of a wireless signal.

### SUMMARY

The following description relates to a method and device for removing and reducing distance measurement errors that occur due to a non-line of sight (NLOS) situation by providing information on the NLOS situation around a GPS receiver when a node equipped with a GPS receiver is used as a criterion of location measurement.

In one general aspect, a method of determining a non-line of sight (NLOS) state around a GPS receiver, includes collecting, from at least one satellite, satellite information including a direction angle, a signal to noise (SNR), and an altitude, selecting a satellite of which the NLOS state is to be determined based on an altitude value of the collected satellite information, and determining whether the selected satellite is in the NLOS state with respect to a direction to the satellite based on the SNR and direction angle included in the satellite information of the selected satellite.

The selecting of the satellite may include selecting a satellite located at a certain altitude or higher as the satellite of which the NLOS state is to be determined.

The determining of the NLOS state may include determining that the satellite information of a satellite determined to be in a line of sight (LOS) state is invalid when an altitude of the satellite is not less than a certain altitude range.

The collecting of the satellite information may include repeatedly collecting the satellite information for a certain time at the same position, and the determining of the NLOS state includes determining the NLOS state of a corresponding direction based on the altitude value and SNR included in the repeatedly collected satellite information.

The method may further include estimating the NLOS state of a peripheral region based on the direction angle of the satellite of which the NLOS state is determined.

The estimating of the NLOS state may include estimating that a region within a certain range from the direction angle of the satellite of which the NLOS state is in the same state as the determined state.

The estimating of the NLOS state may include extending a scope of estimation in consideration of the NLOS state of adjacent satellites.

The extending of the scope of estimation may include extending the scope of estimation to the same state as the state estimated with respect to directions of the adjacent satellites, wherein, in a case where the adjacent satellites have different NLOS states, an extension scope may be smaller in comparison with a case where the adjacent satellites have the same NLOS states.

In another aspect, a device for determining a non-line of sight (NLOS) state around a GPS receiver, the device includes a satellite information collection unit configured to collect, from at least one satellite, satellite information including a direction angle, a signal to noise (SNR), and an altitude, a satellite selection unit configured to select a satellite of which the NLOS state is to be determined based on an altitude value of the satellite information collected by the satellite information collection unit, and an NLOS determination unit configured to determine whether the selected satellite is in the NLOS state with respect to a direction to the satellite based on the SNR and direction angle included in the satellite information of the selected satellite.

The satellite selection unit may select a satellite located at a certain altitude angle or higher as the satellite of which the NLOS state is to be determined.

The NLOS state determination unit may determine that the satellite information of a satellite determined to be in a line of sight (LOS) state is invalid when an altitude of the satellite is not less than a certain altitude range.

The satellite information collection unit may repeatedly collect the satellite information for a certain time, and the NLOS state determination unit may determine the NLOS state of a corresponding direction based on the altitude value and SNR included in the repeatedly collected satellite information.

The NLOS state determination unit may estimate the NLOS state of a peripheral region based on the direction angle of the satellite of which the NLOS state is determined.

The NLOS state determination unit may estimate that a region within a certain range from the direction angle of the satellite of which the NLOS state is in the same state as the determined state.

The NLOS state determination unit may extend a scope of estimation in consideration of the NLOS state of adjacent satellites.

The NLOS state determination unit may extend the scope of estimation to the same state as the state estimated with respect to directions of the adjacent satellites, wherein, in the case where the adjacent satellites have different NLOS states, an extension scope may be smaller in comparison with the case where the adjacent satellites have the same NLOS states.

According to the present invention, information on the NLOS state around the GPS receiver that is a criterion of location measure is provided using satellite information of the GPS when wireless communication-based distance measurement is performed. Therefore, a location calculation error that occurs due to a distance measurement error when a location is measured is reduced, and thus a more precise result of location measurement can be obtained.

Further, in a system where a location is estimated using insufficient distance information and environment information, information that is helpful for selecting a predicted position candidate can be provided.

Other features and aspects will be apparent from the following detailed description, the drawings, and the claims.

### BRIEF DESCRIPTION OF THE DRAWINGS

FIG. 1 is a flowchart illustrating a method of determining an NLOS state around a GPS receiver according to an embodiment of the present invention;

FIG. 2 is a flowchart illustrating a method of selecting a satellite according to an altitude and determining the NLOS state according to an embodiment of the present invention;

FIG. 3 is a reference diagram illustrating the method of selecting a satellite according to an altitude and determining the NLOS state according to an embodiment of the present invention;

FIG. 4 is a flowchart illustrating a method of estimating the NLOS state according to an embodiment of the present invention;

FIG. 5 is a reference diagram illustrating the method of estimating the NLOS state according to an embodiment of the present invention; and

FIG. 6 is a block diagram illustrating a device for determining the NLOS state around the GPS receiver according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, the present invention will be described in detail such that those of ordinary skill in the art can easily understand and reproduce the present invention through embodiments which will be described below with reference to the accompanying drawings.

In the following description, when the detailed description of the relevant known function or configuration is determined to unnecessarily obscure the important point of the present invention, the detailed description will be omitted.

The terms that have been defined as described above may be altered according to the intent of a user or operator, or conventional practice. Therefore, the terms should be defined on the basis of the entire contents of this specification.

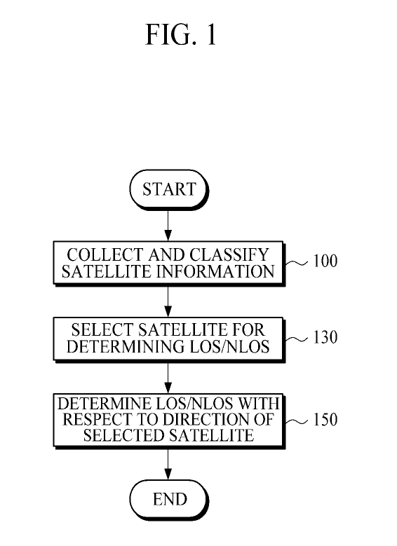

FIG. 1 is a flowchart illustrating a method of determining a non-line of sight (NLOS) state around a GPS receiver according to an embodiment of the present invention.

Referring to FIG. 1, the method of determining the NLOS state around the GPS receiver according to an embodiment of the present invention may include operation 100 for collecting, from at least one satellite, satellite information including a direction angle, a signal to noise (SNR), and an altitude, operation 130 for selecting a satellite of which the NLOS state is to be determined based on the altitude value of the collected satellite information, and operation 150 for determining whether the selected satellite is in the NLOS state with respect to a direction to the satellite based on the SNR and direction angle included in the satellite information of the selected satellite.

A GPS satellite continuously broadcasts a signal including satellite state information, a time and error of a clock installed in the satellite, orbit information and almanac, ephemeris, and coefficients for correcting errors. Based on this information, satellite information such as a state, correct location, and SNR of each satellite.

More specifically, the satellite information may include a direction angle, altitude, and SNR of a satellite. The direction angle indicates a position angle of the satellite with respect to true north, and may be used to determine the NLOS state of a direction from the GPS receiver to the satellite. The altitude indicates an altitude of the satellite with respect to the GPS receiver. Based on a value of the altitude, it may be determined whether a two-dimensional obstacle may be detected in the satellite. The SNR indicates how many noises are included in the received satellite signal. Based on the SNR, the NLOS state may be determined.

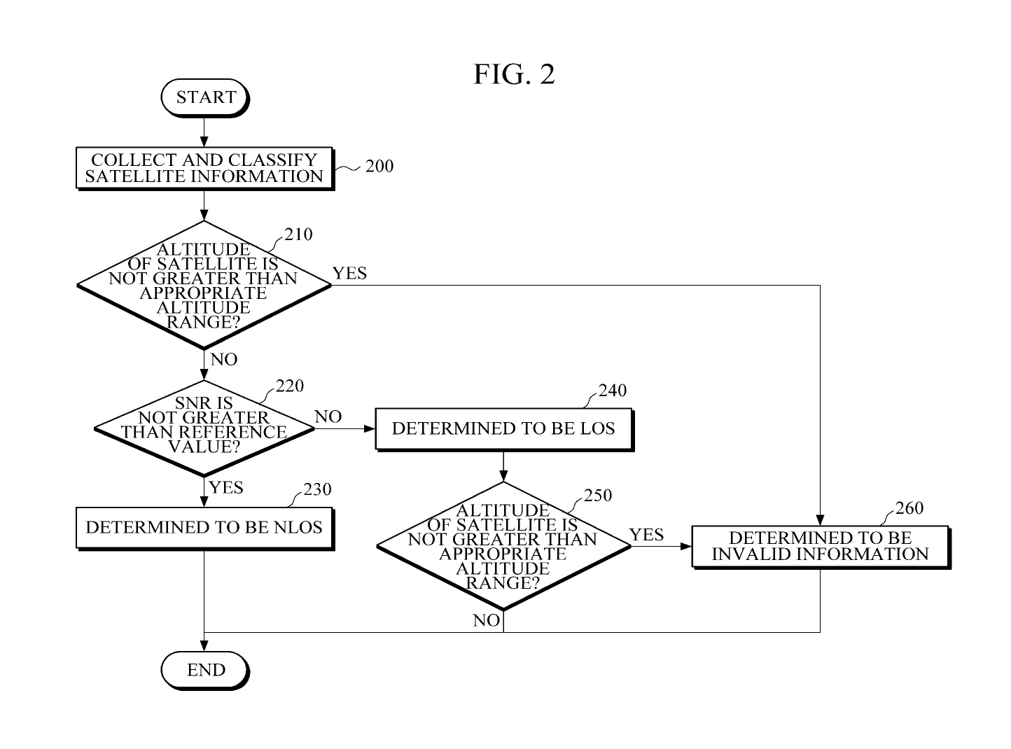

FIG. 2 is a flowchart illustrating a method of selecting a satellite according to an altitude and determining the NLOS state according to an embodiment of the present invention.

Referring to FIG. 2, the satellite information collected from at least one satellite is classified for each satellite (operation 200), and then a satellite of which the NLOS state is to be determined is selected. The satellite selection may be performed based on the altitude value of the satellite information. More specifically, a signal of a satellite located near the horizon passes through a thicker ionospheric layer and atmospheric layer in comparison with a signal of a satellite located at a high altitude, and thus undergoes more serious interference from free electrons and more serious refraction phenomenon caused by the atmospheric layer. Since the satellite signals may be affected by the ground as well as adjacent obstacles, the satellite information of a satellite located below a certain angle of altitude may be determined to be invalid information (operations 210 and 260).

After selecting the satellite of which the NLOS state is to be determined through the altitude value (operation 210), it is determined how may noises are included in the satellite signal through the SNR included in the satellite information of the selected satellite, and, based on this determination, the NLOS state may be determined (operation 220). That is, when an obstacle exists between the satellite and the receiver, the satellite signal is reflected and attenuated by the obstacle. Therefore, when the SNR is not greater than a reference value, it may be determined that the satellite is in the NLOS state (operation 230). When the SNR is 0, it may be determined that the satellite is in the NLOS state. At a value of about 15 to about 20 of the SNR, the NLOS state and the LOS state may be differentiated from each other.

When the satellite is located above the certain angle of altitude, the information may be determined to be invalid even if it is determined that the satellite is in the LOS state (operations 240, 250, and 260). That is, when the altitude of the satellite is too high, the satellite may not be affected by adjacent obstacles. Therefore, even if it is determined that the satellite is in the LOS state, the information may be determined to be invalid. However, when it is determined that the satellite is in the NLOS state, the information may be determined to be valid since the NLOS state indicates that a height of the obstacle is high (operations 240 and 250).

For example, the satellite selection and the NLOS state determination according to the altitude of a satellite may be performed under the conditions shown in Table 1.

TABLE 1

| Angle of altitude(°) | SNR | Determination |
|---|---|---|
| 11 ≦ X ≦ 45 | 31 ≦ SNR | LOS |
| 11 ≦ X ≦ 30 | 0 ≦ SNR ≦ 25 | NLOS |
| 31 ≦ X ≦ 45 | 0 ≦ SNR ≦ 30 | NLOS |
| 46 ≦ X ≦ 90 | 0 ≦ SNR ≦ 25 | NLOS |
| X ≦ 10, 46 ≦ X | — | Discard |
| 11 ≦ X ≦ 30 | 26 ≦ SNR ≦ 35 | Discard |
| 31 ≦ X ≦ 45 | 31 ≦ SNR ≦ 35 | Discard |

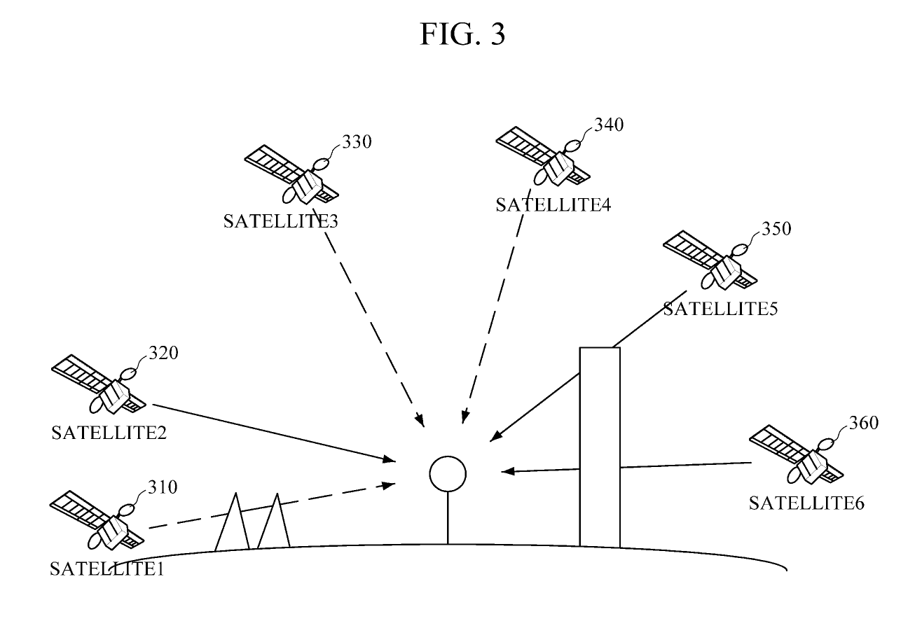

FIG. 3 is a reference diagram illustrating the method of selecting a satellite according to an altitude and determining the NLOS state according to an embodiment of the present invention.

In FIG. 3, it is assumed that a second satellite 320 and a sixth satellite 360 are located in an appropriate altitude range, and third to fifth satellites 330 to 350 are located above the appropriate altitude range. Further, it is assumed that a first satellite 310 is located below the appropriate altitude range. Since the altitude of the first satellite 310 is below the appropriate altitude range, it may be determined that the satellite information of the first satellite 310 is not valid. Since the second and sixth satellites 320 and 360 are located at appropriate altitudes, the NLOS state may be determined for these satellites through the SNR. Since there is no obstacle between the second satellite 320 and the receiver, the SNR is high and it may be determined that the satellite is in the LOS state. Since there is an obstacle between the sixth satellite 360 and the receiver, the SNR is low and thus it may be determined that the satellite is in the NLOS state.

The third and fourth satellites 330 and 340 are located above the appropriate altitude range and thus are not affected by a two-dimensional obstacle. Therefore, in this case, the SNR is high. Accordingly, the satellite information is not determined to be valid even if it is determined that the satellites are in the LOS state. However, in case of the fifth satellite 350, the SNR is low due to the obstacle even though the altitude of the satellite is greater than the appropriate altitude range. Therefore, it is determined that the fifth satellite 350 is in the NLOS state, and this information may be determined to be valid.

In order to improve the accuracy of the NLOS state determination, it may be preferable to collect the satellite information for a certain period of time at a fixed position.

That is, in case of the satellite located at the appropriate altitude, the possibility of the LOS state increases when the SNR is high and the possibility of the NLOS state increases when the SNR is low. After repeating this process for a certain time, the state having a higher possibility is obtained as a result.

In case of the satellite located above the appropriate altitude, the SNR is determined to be invalid information when the SNR is not less than a reference value, and the possibility of the NLOS state increases when the SNR is low. After repeating this process for a certain time, the state having a higher possibility is obtained as a result. For example, the NLOS state is repeatedly determined according to the conditions of Table 1, sufficient information is collected, and then the NLOS state may be finally determined.

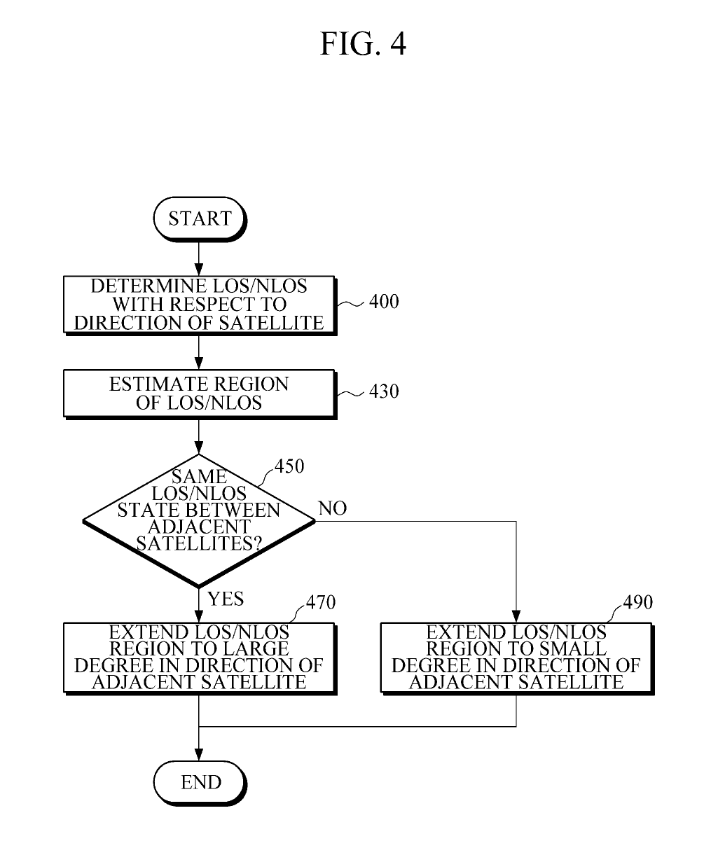

FIG. 4 is a flowchart illustrating a method of estimating the NLOS state according to an embodiment of the present invention. Referring to FIG. 4, the method of determining the NLOS state around the GPS receiver according to an embodiment of the present invention may further include operation 430 for estimating the NLOS state of a peripheral region based on the direction angle of a satellite of which the NLOS state is determined.

The satellite signal received by the GPS receiver is limited, and the NLOS state of all regions around the receiver may not be detected based on the limited satellite information. Therefore, with respect to a direction of which the NLOS state is determined, a region of the NLOS state is extended to estimate the same state not for a line but for a certain space. Therefore, the NLOS state of a certain region, not a line, may be determined.

More specifically, in a case where the NLOS state of a satellite located in a specific direction is determined (operation 400), a region within a certain range of angle with respect to the direction angle of the satellite may be estimated to be in the same state as the determined state (operation 430). For example, when it is determined that the satellite of the specific direction is in the NLOS state with respect to the GPS receiver, a region of a range of ±20° from the direction angle included in the satellite information of the satellite may be estimated to be in the NLOS state.

Further, when it is determined that the satellite of the specific direction is in the LOS state with respect to the GPS receiver, a region of a range of ±20° from the direction angle included in the satellite information of the satellite may be estimated to be in the LOS state. By performing this estimation for all satellites that have been determined to be in the NLOS state, information on a wider region may be provided.

According to an embodiment of the present invention, the method may further include operations 450, 470, and 490 for extending a range of estimation in consideration of whether an adjacent satellite is in the NLOS state.

Here, it may be determined whether two satellites are adjacent to each other based on the direction angle of the satellite information. In the case where both two adjacent satellites are in the NLOS state or LOS state (operation 400), a region within a certain range with respect to the direction angle of a corresponding satellite is estimated to be in the same state (operation 430), and, additionally, a region within a certain range in a direction to an adjacent satellite is estimated to be in the same state as the estimated state, thereby extending a scope of estimation (operations 450, 470, and 490).

In a case where adjacent two satellites are respectively in the LOS state and the NLOS state, a scope of estimation extension may be reduced in comparison with the case where the adjacent two satellites are in the same state (operations 450 and 490).

For example, when two adjacent satellites are in the LOS state with respect to the GPS receiver, a region of additional 10° in a direction to an adjacent satellite may be estimated to be in the LOS state. Further, when two adjacent satellites are in the NLOS state with respect to the GPS receiver, a region of additional 10° in a direction to an adjacent satellite may be estimated to be in the NLOS state.

When two adjacent satellites are respectively in the NLOS state and the LOS state, regions of additional 5° in directions to adjacent satellites may be estimated to be in the same state as respective satellites.

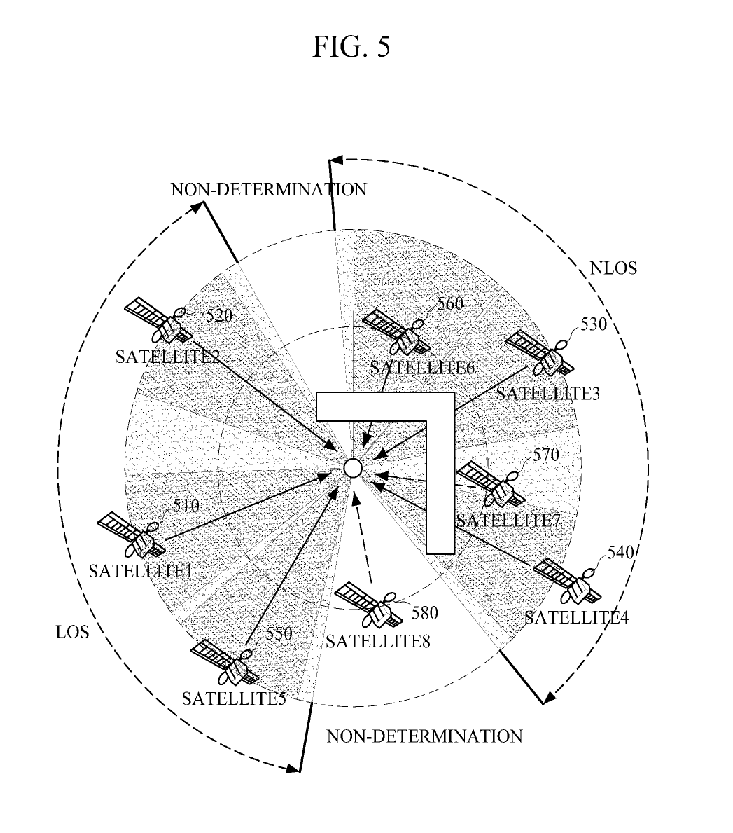

FIG. 5 is a reference diagram illustrating the method of estimating the NLOS state according to an embodiment of the present invention. Referring to FIG. 5, a first satellite 510, a second satellite 520, and a fifth satellite 550 are determined to be in the LOS state, and a third satellite 530 and a fourth satellite 540 are determined to be in the NLOS state. A seventh satellite 570 and an eighth satellite 580 are located above the appropriate altitude range and are in the LOS state. Thus, these satellites are excluded from the NLOS state determination. A sixth satellite 560 is located above the appropriate altitude range, but is determined to be in the NLOS state. Thus, this information is valid. Since the first, second, and fifth satellites 510, 520, and 550 are in the LOS state, regions of a range of ±20° from respective direction angles of the satellites may be estimated to be in the LOS state. Further, since the third, fourth, and sixth satellites 530, 540, and 560 are in the NLOS state, regions of a range of ±20° from respective direction angles of the satellites may be estimated to be in the NLOS state.

Since the first, second, and fifth satellites 510, 520, and 550 are in the LOS state and are adjacent to each other, regions of a range of ±10° in directions to adjacent satellites may be additionally estimated to be in the LOS state. Further, since the third, fourth, and sixth satellites 530, 540, and 560 are in the NLOS state and are adjacent to each other, regions of a range of ±10° in directions to adjacent satellites may be additionally estimated to be in the NLOS state.

The second and sixth satellites 520 and 560 are adjacent to each other, but are respectively in the LOS state and the NLOS state. Thus, a region of a range of 5° from the second satellite 520 to the sixth satellite 560 may be additionally estimated to be in the LOS state. Further, a region of a range of 5° from the sixth satellite 560 to the second satellite 520 may be additionally estimated to be in the NLOS state.

Likewise, the fifth and fourth satellites 550 and 540 are adjacent to each other, but are respectively in the LOS state and the NLOS state. Thus, a region of a range of 5° from the fifth satellite 550 to the fourth satellite 540 may be additionally estimated to be in the LOS state. Further, a region of a range of 5° from the fourth satellite 540 to the fifth satellite 550 may be additionally estimated to be in the NLOS state.

It may be preferable that reliability of determination degrades as a deviation from a reference direction angle increases. Further, in case of a region that does not belong to either of the two states, it is difficult to determine the NLOS state. Thus, this case is not used for an application. When the LOS/NLOS regions overlap each other, it may be preferable to minimize the overlapped region.

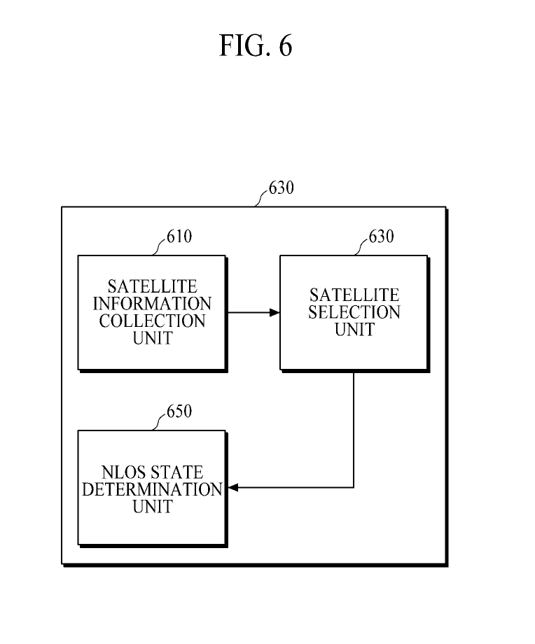

FIG. 6 is a block diagram illustrating a device for determining the NLOS state around the GPS receiver according to an embodiment of the present invention. Referring to FIG. 6, the device for determining the NLOS state around the GPS receiver according to an embodiment of the present invention may include a satellite information collection unit 610 for collecting, from at least one satellite, satellite information including a direction angle, a signal to noise (SNR), and an altitude, a satellite selection unit 630 for selecting a satellite of which the NLOS state is to be determined based on the altitude value of the satellite information collected by the satellite information collection unit, and an NLOS state determination unit 650 for determining whether the selected satellite is in the NLOS state with respect to a direction to the satellite based on the SNR and direction angle included in the satellite information of the selected satellite.

The satellite information collection unit 610 may collect the satellite information including the location information and SNR of a satellite from a satellite signal collected from the satellite. Here, the location information includes information on the direction angle and altitude of the satellite.

The satellite selection unit 630 may select a satellite that is to be used to determine the NLOS state based on the altitude value included in the collected satellite information. More specifically, since the satellite information may be affected by the ground as well as adjacent obstacles, the satellite information of a satellite located below a certain angle of altitude may be determined to be invalid information.

The NLOS state determination unit 650 determines whether the selected satellite is in the NLOS state based on the SNR of the satellite information of the satellite selected by the satellite selection unit 630. More specifically, when an obstacle exists between the satellite and the receiver, the satellite signal is reflected and attenuated by the obstacle. Therefore, the SNR is low. Therefore, the NLOS state determination unit 650 may determine that the satellite is in the NLOS state when the SNR of the satellite information of the satellite selected by the satellite selection unit 630 is not greater than a reference value.

When the altitude of the satellite is greater than an appropriate altitude, the satellite may not be affected by adjacent obstacles. Therefore, even if it is determined that the satellite is in the LOS state, this information may be determined to be invalid. However, even if the altitude of the satellite is greater than the appropriate altitude, when it is determined that the satellite is in the NLOS state, the information may be determined to be valid since the NLOS state indicates that a height of the obstacle is high.

According to an embodiment of the present invention, the satellite information collection unit 610 may repeatedly collect the satellite information for a certain time, and the NLOS state determination unit 650 may determine the NLOS state of a corresponding direction based on the SNR of the repeatedly collected satellite information.

That is, at a value of about 15 to about 20 of the SNR, the NLOS state and the LOS state may be differentiated from each other. Therefore, in order to improve the accuracy of the NLOS state determination, it may be preferable to perform the determination based on the SNR repeatedly measured for a certain period of time at a fixed position.

More specifically, in case of the satellite located at the appropriate altitude, the possibility of the LOS state increases when the SNR is high and the possibility of the NLOS state increases when the SNR is low. After repeating this process for a certain time, the state having a higher possibility is obtained as a result.

In case of the satellite located above the appropriate altitude, the SNR is determined to be invalid information when the SNR is lot less than a reference value for the LOS state, and the possibility of the NLOS state increases when the SNR is not greater than the reference value for the LOS state. After repeating this process for a certain time, the sate having a higher possibility is obtained as a result.

The satellite selection and the NLOS state determination according to the altitude of the satellite may be performed under the conditions shown in Table 1.

According to an embodiment of the present invention, the NLOS state determination unit 650 may estimate the NLOS state of a peripheral region based on the direction angle of a satellite of which the NLOS state is determined.

More specifically, in the case where the NLOS state of a satellite located in a specific direction is determined, a region within a certain range of angle with respect to the direction angle of the satellite may be estimated to be in the same state as the determined state. For example, when it is determined that the satellite of the specific direction is in the NLOS state, a region of a range of ±20° from the direction angle included in the satellite information of the satellite may be estimated to be in the NLOS state.

Further, when it is determined that the satellite of the specific direction is in the LOS state with respect to the GPS receiver, a region of a range of ±20° from the direction angle included in the satellite information of the satellite may be estimated to be in the LOS state. By performing this estimation for all satellites that have been determined to be in the NLOS state, information on a wider region may be provided.

In the case where both two adjacent satellites are in the NLOS state or LOS state, the NLOS state determination unit 650 estimates that a region within a certain range with respect to the direction angle of a corresponding satellite is in the same state, and, additionally, estimates that a region within a certain range in a direction to an adjacent satellite is in the same state as the estimated state, thereby extending a scope of estimation. In the case where adjacent two satellites are respectively in the LOS state and the NLOS state, a scope of estimation extension may be reduced in comparison with the case where the adjacent two satellites are in the same state.

For example, when both two adjacent satellites are in the LOS state, a region of additional 10° in a direction to the adjacent satellite may be estimated to be in the LOS state. Further, when both two adjacent satellites are in the NLOS state, a region of additional 10° in a direction to the adjacent satellite may be estimated to be in the NLOS state.

When two adjacent satellites are respectively in the NLOS state and the LOS state, regions of additional 5° in directions to adjacent satellites may be estimated to be in the same state as respective satellites.

The satellite information collection unit 610, the satellite selection unit 630, and the NLOS state determination unit 650 may be implemented as microprocessors, and specific operations thereof may not be clearly differentiated.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A method of determining a non-line of sight (NLOS) state around a GPS receiver, the method comprising:
collecting, from at least one satellite, satellite information comprising a direction angle, a signal to noise (SNR), and an altitude;
selecting a satellite of which the NLOS state is to be determined based on an altitude value of the collected satellite information; and
determining whether the selected satellite is in the NLOS state with respect to a direction to the satellite based on the SNR and direction angle included in the satellite information of the selected satellite.

2. The method of claim 1, wherein the selecting of the satellite comprises selecting a satellite located at a certain altitude or higher as the satellite of which the NLOS state is to be determined.

3. The method of claim 1, wherein the determining of the NLOS state comprises determining that the satellite information of a satellite determined to be in a line of sight (LOS) state is invalid when an altitude of the satellite is not less than a certain altitude range.

4. The method of claim 1, wherein the collecting of the satellite information comprises repeatedly collecting the satellite information for a certain time at the same position, and the determining of the NLOS state comprises determining the NLOS state of a corresponding direction based on the altitude value and SNR included in the repeatedly collected satellite information.

5. The method of claim 1, further comprising estimating the NLOS state of a peripheral region based on the direction angle of the satellite of which the NLOS state is determined.

6. The method of claim 5, wherein the estimating of the NLOS state comprises estimating that a region within a certain range from the direction angle of the satellite of which the NLOS state is in the same state as the determined state.

7. The method of claim 6, wherein the estimating of the NLOS state comprises extending a scope of estimation in consideration of the NLOS state of adjacent satellites.

8. The method of claim 7, wherein the extending of the scope of estimation comprises extending the scope of estimation to the same state as the state estimated with respect to directions of the adjacent satellites, and
in a case where the adjacent satellites have different NLOS states, an extension scope is smaller in comparison with a case where the adjacent satellites have the same NLOS states.

9. A device for determining a non-line of sight (NLOS) state around a GPS receiver, the device comprising:
a satellite information collection unit configured to collect, from at least one satellite, satellite information comprising a direction angle, a signal to noise (SNR), and an altitude;
a satellite selection unit configured to select a satellite of which the NLOS state is to be determined based on an altitude value of the satellite information collected by the satellite information collection unit; and
an NLOS determination unit configured to determine whether the selected satellite is in the NLOS state with respect to a direction to the satellite based on the SNR and direction angle included in the satellite information of the selected satellite.

10. The device of claim 9, wherein the satellite selection unit selects a satellite located at a certain altitude angle or higher as the satellite of which the NLOS state is to be determined.

11. The device of claim 9, wherein the NLOS state determination unit determines that the satellite information of a satellite determined to be in a line of sight (LOS) state is invalid when an altitude of the satellite is not less than a certain altitude range.

12. The device of claim 9, wherein the satellite information collection unit repeatedly collects the satellite information for a certain time, and the NLOS state determination unit determines the NLOS state of a corresponding direction based on the altitude value and SNR included in the repeatedly collected satellite information.

13. The device of claim 9, wherein the NLOS state determination unit estimates the NLOS state of a peripheral region based on the direction angle of the satellite of which the NLOS state is determined.

14. The device of claim 13, wherein the NLOS state determination unit estimates that a region within a certain range from the direction angle of the satellite of which the NLOS state is in the same state as the determined state.

15. The device of claim 14, wherein the NLOS state determination unit extends a scope of estimation in consideration of the NLOS state of adjacent satellites.

16. The device of claim 15, wherein the NLOS state determination unit extends the scope of estimation to the same state as the state estimated with respect to directions of the adjacent satellites, and
in a case where the adjacent satellites have different NLOS states, an extension scope is smaller in comparison with a case where the adjacent satellites have the same NLOS states.

17. The method of claim 4, further comprising estimating the NLOS state of a peripheral region based on the direction angle of the satellite of which the NLOS state is determined.

18. The device of claim 12, wherein the NLOS state determination unit estimates the NLOS state of a peripheral region based on the direction angle of the satellite of which the NLOS state is determined.
